(19) United States
(12) Patent Application Publication
(10) Pub. No.: US 2003/0201290 A1
(43) Pub. Date: Oct. 30, 2003

(54) Angled ski rack attachment for a sports rack

(75) Inventor: Eivind Clausen, Bellingham, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Allsop, Inc.

(21) Appl. No.: 10/422,928

(22) Filed: Apr. 23, 2003

Related U.S. Application Data
(60) Provisional application No. 60/376,698, filed on Apr. 30, 2002.

(51) Int. Cl. B60R 9/00; B60R 11/00

(52) U.S. Cl. 224/519; 224/523; 224/536; 224/537

(57) ABSTRACT

A rack assembly (100) for attachment to the back of a vehicle is disclosed. The rack assembly includes an upper retaining member (160) and a lower retaining member (180), the upper and lower retaining members being offset vertically and transversely, such that elongate gear, for example, skis or other sports equipment, will be oriented generally at an angle between about 20 degrees and about 70 degrees, near the rear of the vehicle. Protective sheaths (163, 183) may be provided to protect the retained gear. In one embodiment the upper and lower retaining members are removably attachable to a support assembly (120) that engages the hitch (92) at the back of a vehicle. In an embodiment of the invention, a plurality of upper and lower retaining members (220, 240) attach to a frame (204) disposed near the rear of the vehicle.

### CROSS-REFERENCE TO RELATED APPLICATION

This application claims the benefit of U.S. Provisional Patent Application No. 60/376,698, filed on Apr. 30, 2002, the disclosure of which is hereby expressly incorporated by reference, and priority from the filing date of which is hereby claimed under 35 U.S.C. §120.

### FIELD OF THE INVENTION

The present invention is directed to a rack assembly for retaining gear and, in particular, to rack assemblies that are attachable to vehicles.

### BACKGROUND OF THE INVENTION

Vehicle-mounted rack assemblies for transporting sporting gear such as bicycles, snowboards, snow shoes, skis, etc., are well known in the art. There are two general types of such racks, sometimes called ski racks, in common use. One type of ski rack allows the user to mount skis or other gear, on top of a vehicle, usually in a horizontal orientation. Roof-mounted ski racks have several disadvantages. For example, roof-mounted racks increase the total height of the vehicle, which may create headroom problems in garages and the like, particularly for vehicles such as sports utility vehicles, which are already quite tall. Also, in roof-mounted racks it can be difficult to access the gear rack and to attach the gear to the gear rack, especially for taller vehicles. The second type of gear rack is disposed at the rear of the vehicle and allows the user to mount skis or other gear at the rear of the vehicle, typically in a vertical, or substantially vertical, orientation. While rear-mounted ski racks are generally easier to access, it can be problematic to mount relatively long gear on such racks-for example, when headroom constraints are a factor.

In particular, gear that is relatively long, such as skis, snowboards, luggage pods, and the like, presents a problem for currently available rear-mounted rack assemblies. Because the skis or snowboards are positioned vertically in rear-mounted gear racks, they often extend too high above the vehicle to pass through the threshold of common enclosures, such as garages and carports. Luggage pods are also sometimes mounted transversely, extending beyond the width of the vehicle. Skis, snowboards, or other mounted gear may strike items, such as garages, other vehicles, etc., and may become damaged and/or may damage the struck item or vehicle. Moreover, it will be appreciated that rear-mounted skis (or other gear) must be positioned sufficiently high above ground level that the gear will not impact debris or other ground irregularities during transport. This may be particularly important in off-road conditions or on snowy roads. Examples of rear-mounted gear racks are disclosed in U.S. Pat. Nos. 5,992,720 and 5,330,312.

It should also be appreciated that skis and snowboards are frequently too long to be positioned horizontally on the rear end of the vehicle. If the skis or snowboards extend beyond the width of the vehicle, the skis may present a hazard to passers by because they may not be aware of the gear and may collide with it.

Because positioning skis or snowboards horizontally or vertically within a rear-mounted rack assembly may present a safety hazard, a need exists for improved rear-mounted rack designs.

### SUMMARY OF THE INVENTION

A rack assembly, such as the type that might be used to secure skis, sports equipment, or other elongate gear to the rear of a vehicle, is disclosed. The rack assembly includes a lower retaining member that is disposed to one side of the vehicle, and is adapted to receive one end of the gear to be retained. An upper retaining member is also provided, disposed above the lower retaining member, and toward the opposite side of the vehicle. The upper retaining member includes a clamp for holding the gear and the upper and lower retaining members are positioned such that the cooperatively retained elongate gear is generally disposed generally diagonally across the rear of the vehicle, at an angle of between about 20 and about 70 degrees.

In an embodiment of the invention, a support assembly attaches to the vehicle, such as to the vehicle hitch. The support assembly receives the lower retaining member that includes a rearwardly-extending rigid hoop and the upper retaining member that may include a rearwardly-extending fixed bar, and a hinged second bar that swings away from the fixed bar to receive or release the gear, and swings toward the fixed bar to retain the gear. A lock assembly my be provided to lock the hinged bar in the retaining position.

In an embodiment of the invention, a pliant sheath is provided about a portion of the lower retaining member and about a portion of the upper retaining member, to facilitate retaining the gear while protecting the gear from damage.

In another embodiment of the invention, a frame attaches to the support member. The frame is adapted to receive one or more upper retaining members and one or more lower retaining members. In a disclosed embodiment, the upper and lower retaining members are hingedly attached to the frame, whereby the retaining members may be folded away, e.g., for easy storage.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a rear view of a gear rack according to the present invention, shown installed on the back of a vehicle;

FIG. 2 is an isometric view of the gear rack of FIG. 1, with skis retained on the gear rack, and the vehicle removed, for clarity;

FIG. 3 is a side view of the gear rack of FIG. 2, with skis retained thereon;

FIG. 4 is a front view of the gear rack of FIG. 2, with skis retained thereon;

FIG. 5 is a plan view of the gear rack of FIG. 2, with skis retained thereon;

FIG. 6 is a fragmentary view of the gear rack of FIG. 2, showing the operation of the locking member;

FIG. 7A is an isometric view of the upper retaining member of the gear rack shown in FIG. 2;

FIG. 7B is an exploded isometric view of the upper retaining member shown in FIG. 7A;

FIG. 7C is an isometric view of the upper retaining member shown in FIG. 2, with the spacing bar removed;

FIG. 8A is an isometric view of the lower retaining member of the gear rack shown in FIG. 2;

FIG. 8B is an exploded isometric view of the lower retaining member shown in FIG. 8A;

FIG. 9 is a second embodiment of a gear rack according to the present invention;

FIG. 10 is a close-up, fragmentary exploded view showing the attachment of the gear rack of FIG. 9 with a support assembly; and

FIG. 11 is an isometric view of the gear rack of FIG. 9, shown folded for storage and/or transportation.

### DETAILED DESCRIPTION OF THE PREFERRED EMBODIMENT

An embodiment of the invention will now be described in detail, with reference to the figures, wherein like parts have like numbers. As used herein, the terms “horizontal” and “vertical” are to be understood to mean the respective directions defined with respect to the orientation of the vehicle to which the described rack assembly is suitably attached. For example, horizontal refers to a direction parallel to a plane defined generally by the base of the vehicle, and vertical refers to a direction perpendicular to that plane.

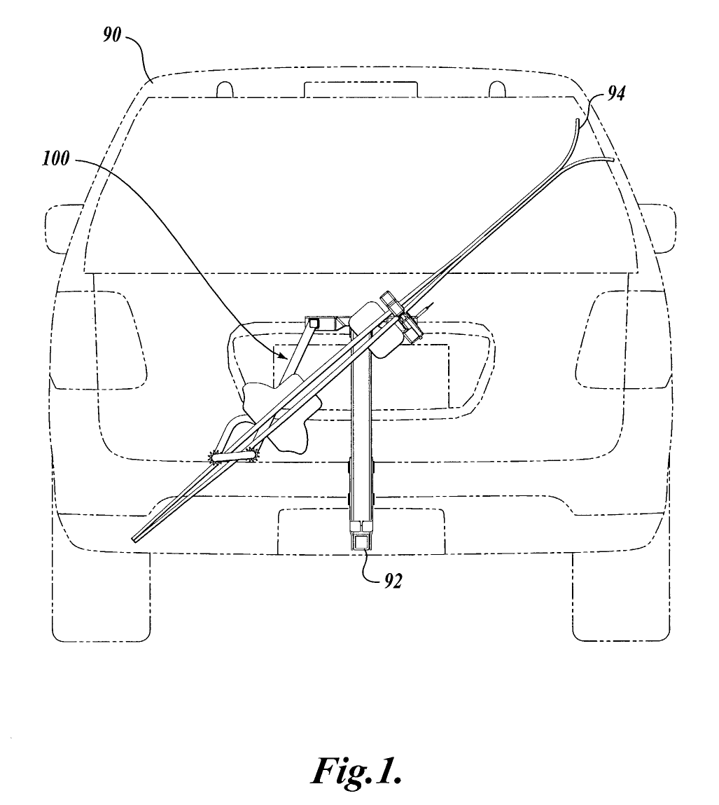

A rack assembly 100 in accordance with the present invention is shown in FIG. 1, attached to the rearward end of a vehicle 90. A pair of skis 94 is retained by the rack assembly 100. In this embodiment, the rack assembly 100 is attached to the vehicle hitch 92, although it will be readily appreciated that other mechanisms for attaching a rack assembly to a vehicle could alternatively be utilized without departing from the scope and teaching of the present invention.

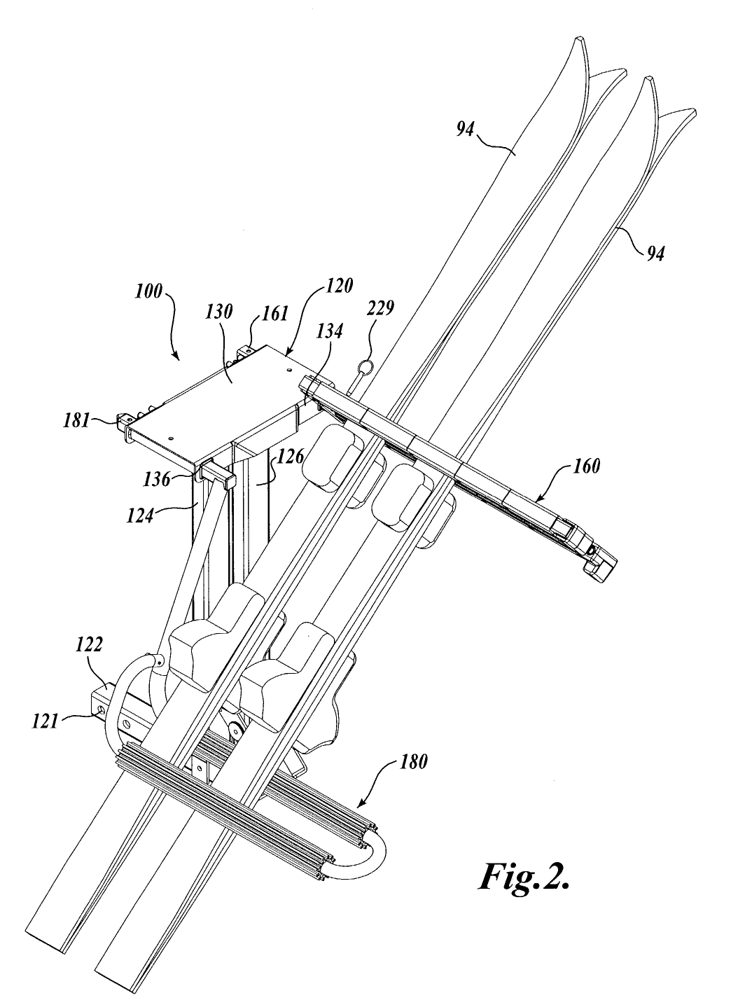

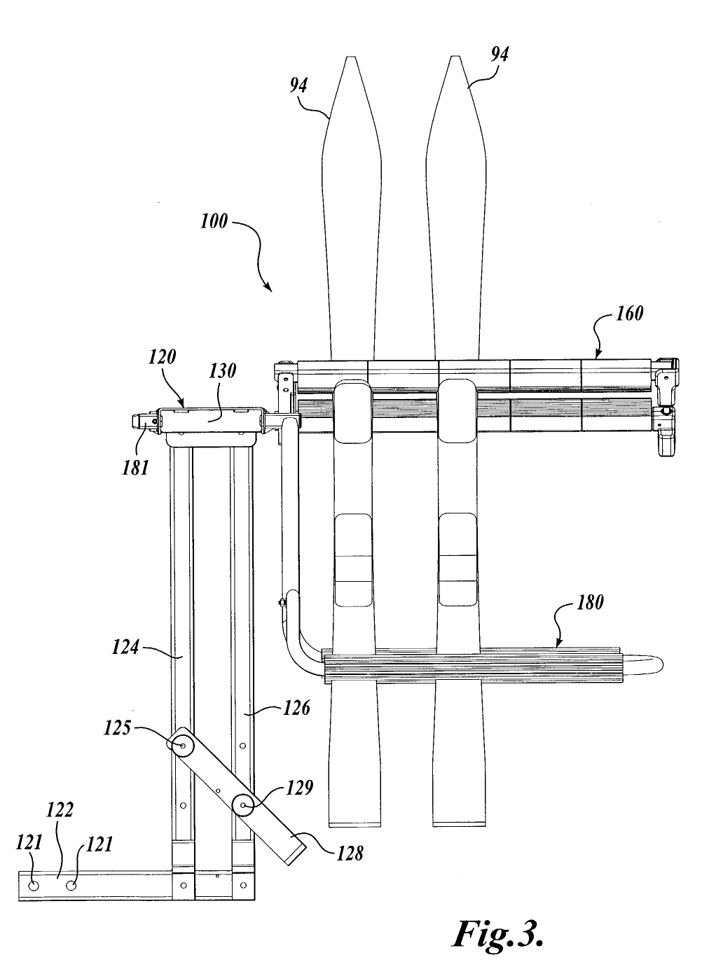

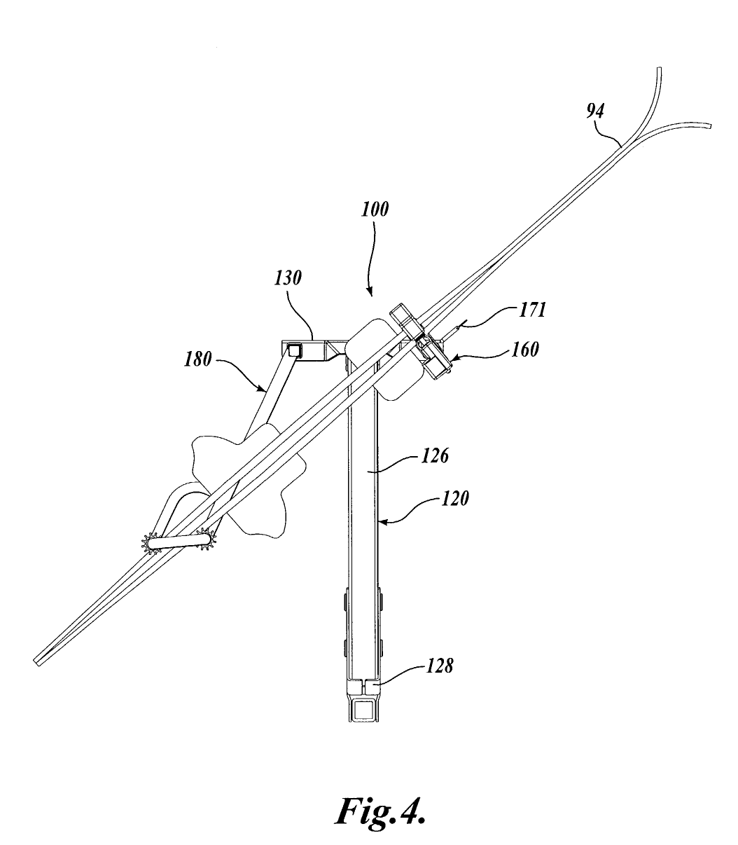

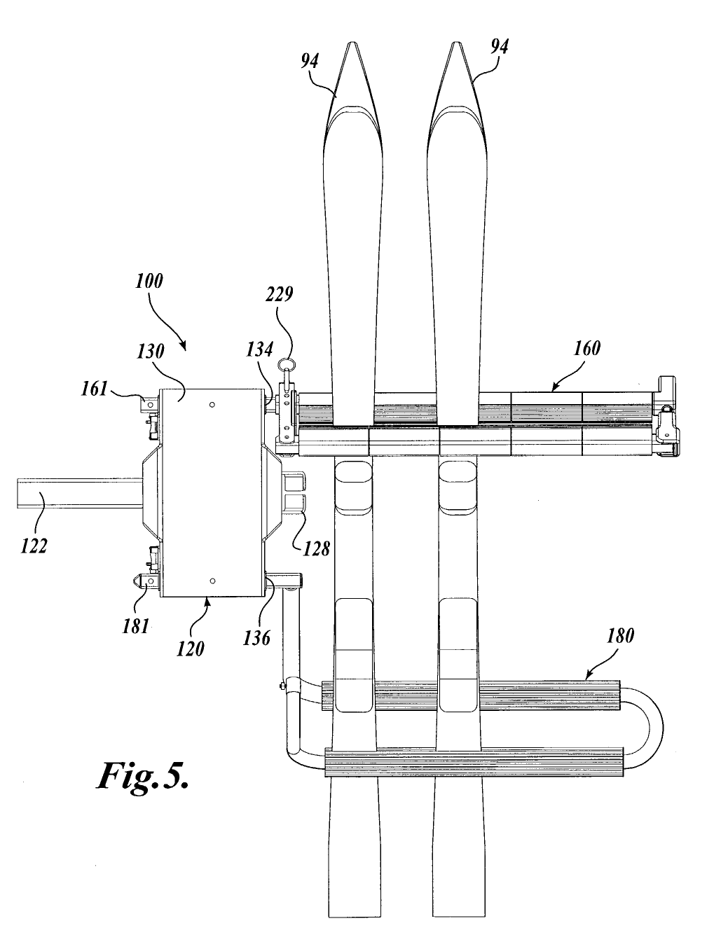

Referring now to FIGS. 2-5, wherein FIG. 2 shows a perspective view of the rack assembly 100 with two pairs of skis 94 retained therein, and FIGS. 3, 4, and 5 show side, front, and plan views, respectively. The major components of this embodiment of the rack assembly 100 are a support assembly 120, an upper retaining member 160, and a lower retaining member 180. The support assembly 120 may be—but the present invention is expressly not limited to—a commercially available equipment rack, such as the Softride™ Access DX and LT sports racks manufactured by Softride, Inc., of Bellingham, Wash.

The lower end of the support assembly 120 includes a square post 122 that is adapted to be slidably inserted into the vehicle hitch 92 (FIG. 1), thereby attaching the support assembly 120 to the vehicle 90. The square post 122 may include one or more aperture(s) 121 that are intended to accommodate a locking pin (not shown), which may be used to lock the square post 122 to the vehicle hitch 92 to preclude the support assembly 120 from disengaging the hitch 92. Two swing arms 124, 126 are pivotally attached near the distal end of the square post 122 at one end, and are pivotally attached to a mounting plate 130 at the opposite end, such that the swing arms 124, 126 are approximately parallel to each other, and the mounting plate 130 is generally horizontally disposed. The pivotal connections at opposite ends of the swing arms 124, 126 allow the swing arms 124, 126 and the mounting plate 130 to move, or swing, in an arc with respect to the square post 122. It should be appreciated that the mounting plate 130 will maintain approximately the same angular orientation throughout the motion of the swing arms 124, 126. In other words, as the swing arms 124, 126 pivot such that the mounting plate 130 swings outwardly, the mounting plate 130 will remain generally horizontally disposed.

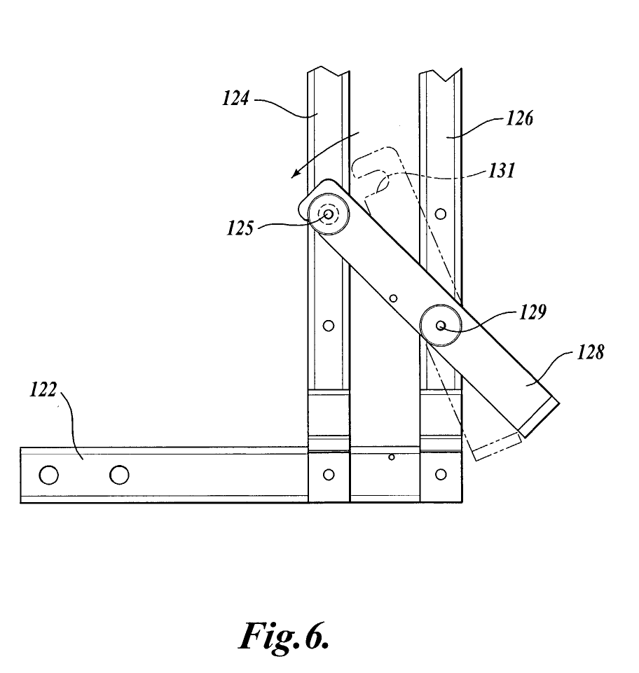

As seen most clearly in FIG. 6, a locking member 128, preferably a U-shaped member, is attached to the rearward swing arm 126 with a pivot 129, such that the legs of the locking member 128 extend toward the forward swing arm 124. The forward swing arm 124 includes a locking post 125 that is adapted to releasably engage a recess 131 in the locking member 128. When the recess 131 of the locking member 128 engages the locking post 125, the swing arms 124, 126 are prevented from pivoting and are locked in the upright position. In order to pivot the swing arms 124, 126 and thereby swing the mounting plate 130 rearwardly, the user must release the locking member 128 by rotating the locking member about the pivot 129—which may be conveniently accomplished, for example, by depressing the end of the locking member 128 with the user's foot. The positions of the locking post 125 and recess 131 in the locking member 128 are selected to lock the swing arms 124, 126 in a generally vertical orientation.

Referring again to FIGS. 2-5, the mounting plate 130 includes a pair of spaced-apart keyed apertures 134, 136 (i.e., non-circular), preferably square apertures that are adapted to receive correspondingly keyed posts 161, 181 on the upper and lower retaining members 160, 180, respectively. The upper retaining member 160 can thereby be removably attached to the support assembly 120 by inserting the post 161 into the aperture 134, and the lower retaining member 180 can be removably attached to the support assembly 120 by inserting post 181 into the aperture 136. Similar to the support assembly square post 122 described above, apertures and locking pins 171 (one shown) may be provided to allow the user to lock the keyed posts 161, 181 in place after insertion into the mounting plate 130 apertures 134, 136.

As seen most clearly in FIG. 1, when the rack assembly 100 is attached to the vehicle 90, the upper retaining member 160 is disposed toward one side of the vehicle 90 and at a relatively high location, and the lower retaining member 180 is disposed toward the opposite side of the vehicle 90 and at a relatively low location. The elongate equipment, such as skis 94, is retained by both the upper retaining member 160 and the lower retaining member 180 and is thereby oriented at an angle, generally diagonally across the back of the vehicle 90. In the preferred embodiments, the gear is disposed generally at an angle between 20 degrees and 70 degrees with respect to the vertical when retained by the rack assembly 100, and most preferably between about 35 degrees and 55 degrees. Although the figures show the rack assembly 100 with the lower retaining member 180 on the left side and the upper retaining member on the right side, it will be readily apparent that a rack assembly could equivalently be made to reverse this orientation or, as in the preferred embodiment, permitting the assembly to be configured in either direction.

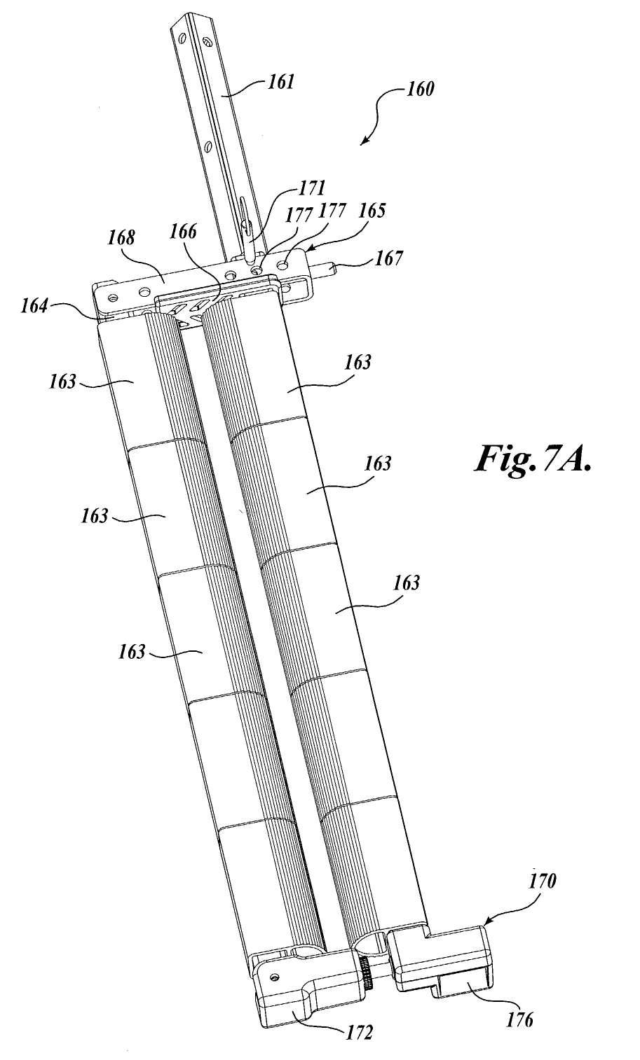

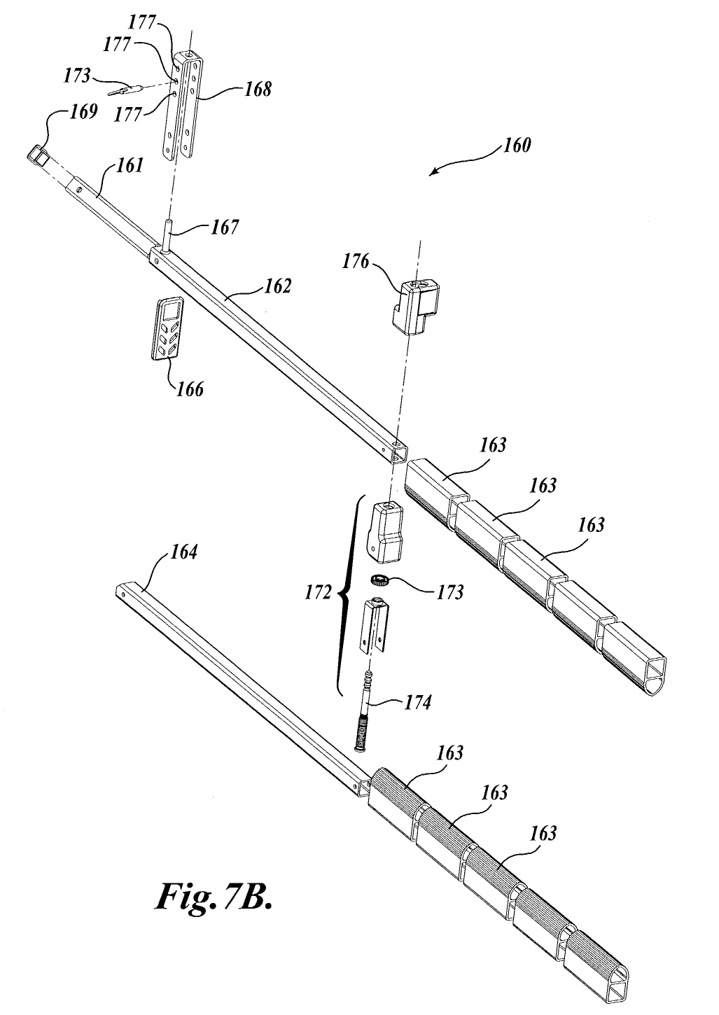

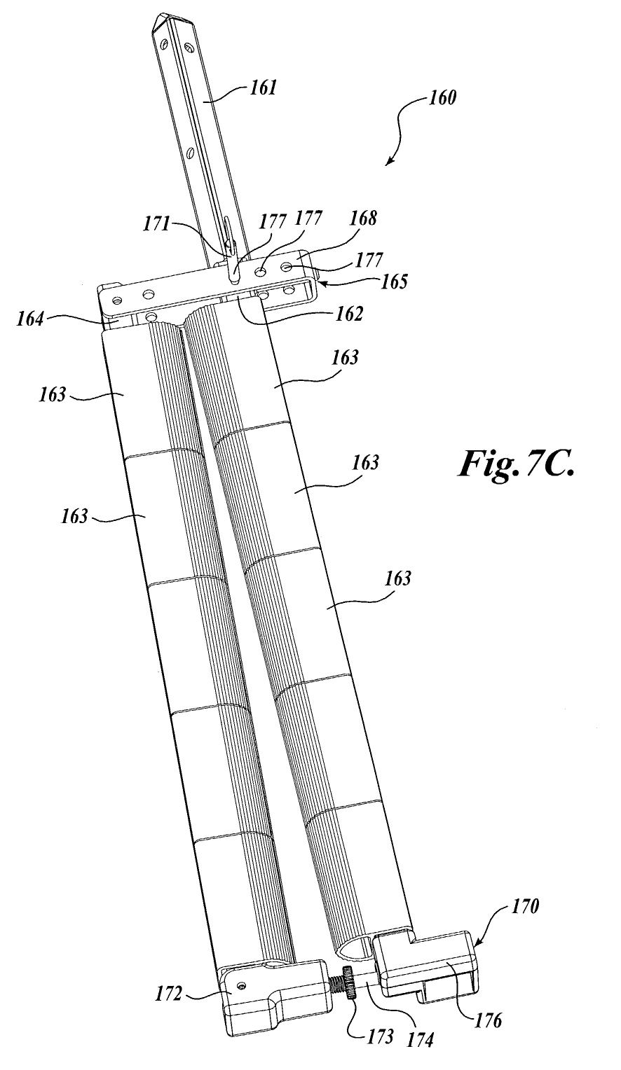

Referring now to FIGS. 7A-7C, the upper retaining member 160 includes a fixed bar 162 and a hinged bar 164, each bar having a protective sheath, preferably made up of a plurality of sheath segments 163 adapted to protect the equipment retained by the upper retaining member 160 from scratches and the like, while also providing a firm grip on the gear. FIG. 7A shows the upper retaining member 160 in isolation and FIG. 7B shows an exploded view of the upper retaining member 160 with minor connecting hardware removed for clarity. The upper retaining member 160 includes the fixed bar 162 that is rigidly attached to the keyed post 161, generally axially aligned therewith. The hinged bar 164 is hingedly attached to the fixed bar 162 with a hinge assembly 165. In the disclosed embodiment, the hinge assembly 165 includes a U-shaped bracket 168 that engages a post 167 near the proximal end of the fixed bar 162, and pivotally attaches to the hinged bar 164 such that the hinged bar 164 can swing away from the fixed bar 162 at one end. A plurality of sheath segments 163 slidably engages both the fixed bar 162 and the hinged bar 164, providing a relatively pliable interface to the gear retained by the upper retaining member 160.

A lock assembly 170 is provided at the distal end of the fixed and hinged bars 162, 164 such that the bars 162, 164 can be secured in a closed position. In the disclosed embodiment, the lock assembly includes a lockable post assembly 172 attached near the distal end of the hinged bar 164, and a post receptor 176 attached near the distal end of the fixed bar 162, and positioned to receive a portion of the post assembly 172. One or more end caps 169 (one shown) may be provided to seal the post 161 and/or the bars 162, 164 from dirt and for aesthetic purposes.

As seen most clearly by comparing FIG. 7A with FIG. 7C, in the preferred embodiment, the hinge assembly 165 and the lock assembly 170 are adjustable such that the spacing between the fixed bar 162 and the hinged bar 164, in the closed position, may be selected to accommodate whatever gear is to be retained by the upper retaining member 160. For example, the U-shaped bracket 168 includes a plurality of spaced-apart apertures 177 that are positioned to allow the bracket 168 to be selectively attached to the fixed bar 162 in different locations with one or more locking pins 171, thereby adjusting the spacing between the fixed bar 162 and the hinged bar 164. An optional protective spacer plate 166 may be provided to protect the gear from damage, and/or to improve operation of the hinge assembly 165 when the fixed bar 162 and the hinged bar 164 are assembled for relatively wide spacing. In the preferred embodiment, the protective spacer plate is made from a relatively soft and pliable material, such as a plastic. The lockable post assembly 172 may include a thumbscrew 173 that threadably engages a locking post 174 to select the desired spacing at the distal end of the fixed and hinged bars 162, 164.

It will be appreciated that although the currently preferred upper retaining member has been described with a fixed bar 162 and a hinged bar 164 configured to receive the gear, other mechanisms for attaching the gear are contemplated and are within the scope of the present invention. For example, it is known in the art to use a fixed bar having curved clamps, which may be locking clamps, to secure gear to a retaining member. Alternatively, cables, chains, elastic cords, or other flexible members may be used to attach gear to the retaining member. Other attachment mechanisms may also be used, as are well known in the art.

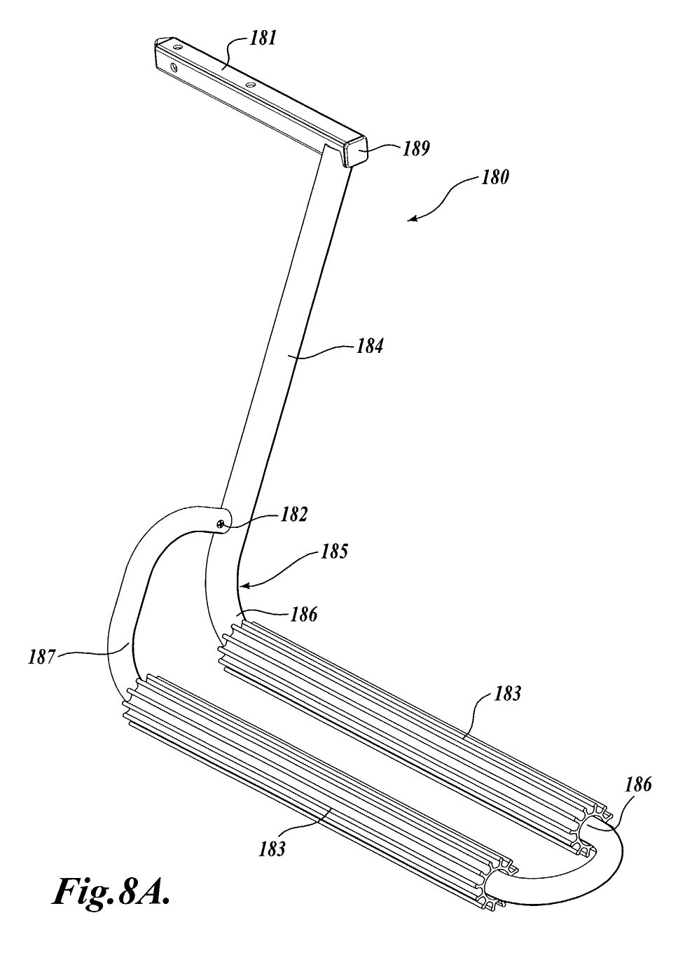

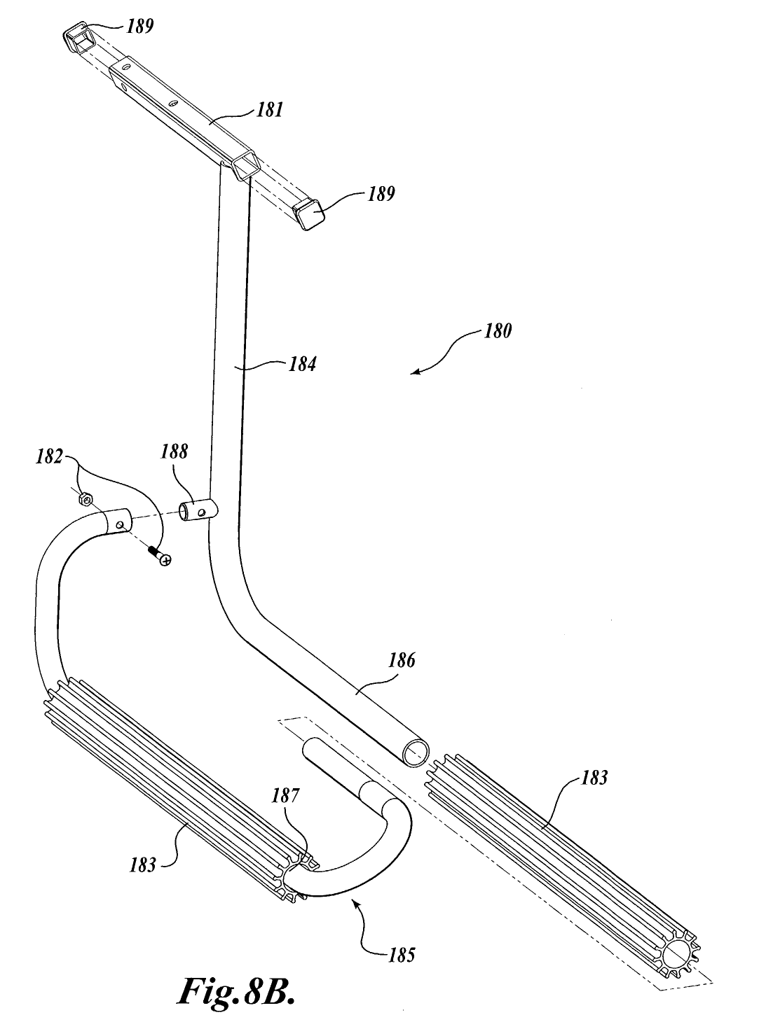

FIG. 8A shows the lower retaining member 180 in isolation, and FIG. 8B shows an exploded view of the lower retaining member 180, with minor connecting hardware removed for clarity. The lower retaining member 180 of the disclosed embodiment includes an extension bar 184 rigidly attached to the keyed post 181 and extending generally downwardly and outwardly therefrom. A rearwardly extending hoop assembly 185 is attached to the extension bar 184. The hoop assembly 185 forms an elongate, fixed hoop that is adapted to receive one end of the gear, such as skis 94 (FIG. 1). As seen most clearly in FIG. 8B, the extension bar 184 and hoop assembly 185 may conveniently be made from interlocking tubular elements. In the disclosed embodiment, a lower hoop element 187 is insertable into an upper hoop element 186 at one end, and engages an attachment post 188 fixed to the extension bar 184 at the other end. A screw and nut assembly 182 may be used to lock the lower hoop element 187 in place.

The hoop assembly 185 is provided with a pair of protective sheaths 183, that are disposed about portions of the hoop assembly 185 to protect the retained gear from scratches and the like, while also providing a firm grip on the gear. A pair of end caps 189 may also be provided, as discussed above.

To use the rack assembly 100, the user typically first attaches the support assembly 120 to the vehicle 90 by inserting the square post 122 into the hitch 92. A locking pin may be used to secure the support assembly 120 in place. The upper retaining member 160 and the lower retaining member 180 are then attached to the support assembly 120 by inserting the keyed posts 161, 181 into the respective keyed apertures 134, 136 on the mounting plate 130. The hinged bar 164 of the upper retaining member 160 is then pivoted upwardly, and the gear, such as skis 94, is inserted through the hoop assembly 185 of the lower retaining member 180 near one end and against the fixed bar 162 of the upper retaining member 160 near the other end. The skis 94 are therefore disposed generally diagonally across the back of the vehicle 90. The hinged bar 164 is then rotated toward the fixed bar 162, and latched with the lock assembly 170 to secure the skis 94 to the rack assembly 100. It should be readily apparent that the hoop assembly 185 is oriented such that the skis 94 (or other gear) are snugly accommodated by the sheaths 183 of the hoop assembly 185, thereby cooperating with the upper retaining member 160 to support and secure the skis 94. It should be appreciated that the aperture or slot defined by the hoop assembly 185 of the lower retaining member 180 is fairly wide, making it easy to insert one end of the skis 94 into the lower retaining member 180 by orienting the skis 94 generally vertically during insertion. When the upper end of the skis 94 are rotated toward the upper retaining member 160, the lower end of the skis 94 will snug up against the sheaths 183 of the hoop assembly 185, to securely retain the skis 94.

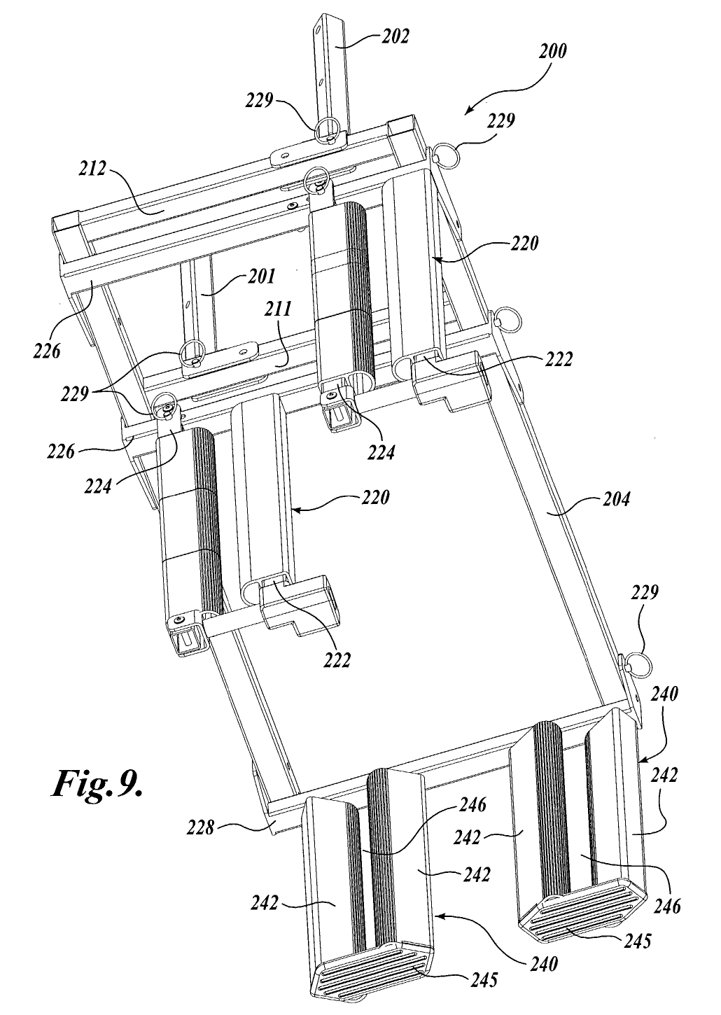

A second embodiment of the present invention is shown in FIGS. 9-11. In this second embodiment, a retaining frame assembly 200 is used in place of the upper and lower retaining members 160, 180. The retaining frame assembly 200 is intended to be used with a support assembly, such as the support assembly 120 described above, although it will be readily apparent that with straightforward modifications the retaining frame may be modified to attach to a vehicle using alternative mounting hardware, such as are well known in the art.

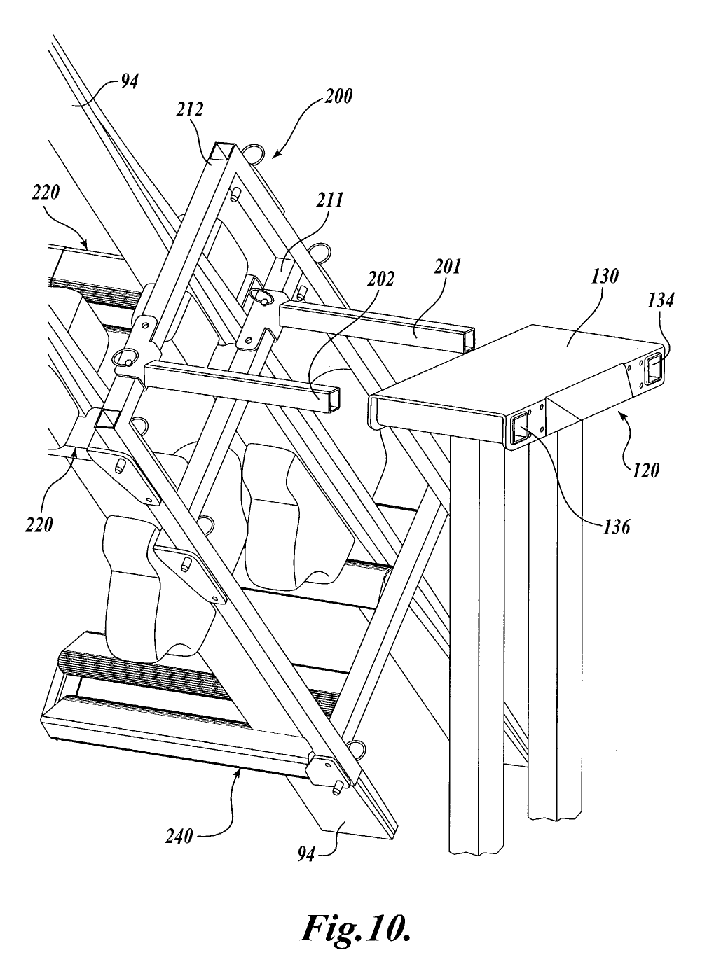

The retaining frame assembly 200 includes a frame 204 having a pair of keyed posts 201, 202, preferably square posts, extending forwardly therefrom, which are adapted to slidably engage the keyed apertures 134, 136 of the support assembly 120, such that the support frame assembly 200 may be attached to a vehicle. The keyed posts 201, 202 may conveniently be hingedly attached to the frame 204 to be folded out of the way when the assembly 200 is in storage. In a preferred embodiment, the posts 201, 202 are hingedly mounted on transverse rails 211, 212. As seen most clearly in FIG. 10, the keyed posts 201, 202 are disposed at diagonal or skewed positions with respect to the frame 204, such that when the keyed posts 201, 202 are inserted into horizontally disposed keyed apertures 134, 136 of the mounting plate 130 (FIG. 10), the frame 204 will be disposed at an angle.

One or more upper retaining members 220 (two shown) extend rearwardly from the frame 204. The upper retaining members 220 preferably include fixed bar 222 and hinged bar 224 elements, substantially the same as the upper retaining member 160 described above. The structure and operation of these upper retaining members 220 are substantially the same as the upper retaining member 160 described above, and for clarity, that description will not be repeated here.

An equal number of lower retaining members 240 (two shown) extend rearwardly from the frame, disposed below and offset from, corresponding upper retaining members 220. The lower retaining members 240 function similarly to the lower retaining members 180 described above, by providing a substantially fixed slot or hoop for receiving one end of the gear, such as skis 94. In this embodiment, the lower retaining members 240 are similar in appearance to the upper retaining members 220. For simplicity of manufacture and use, however, the lower retaining members 240 do not include a hinged bar, but rather are made from two parallel, sheathed fixed bars 242 that are attached to the frame 204 at their proximal ends and joined with an end plate 245 at their distal ends, thereby defining an open slot 246 for receiving one end of the skis 94.

As shown in the figures, the upper retaining members 220 may be attached to the frame 204 with one or more first hinged rails 226 (two shown) that hingedly interconnect the frame 204 and the upper retaining members 220. The first hinged rails 226 are preferably oriented to permit the upper retaining members 220 to fold generally downwardly toward the frame. Similarly, the lower retaining members 240 may be attached to the frame 204 with one or more second hinged rails 228 (one shown), that hingedly interconnect the frame 204 and the lower retaining members 240. The second hinged rail 228 preferably permits the lower retaining members 240 to swing upwardly, toward the frame 204. The first and second hinged rails may preferably be locked in the extended position, shown in FIG. 9, by locking pins 229.

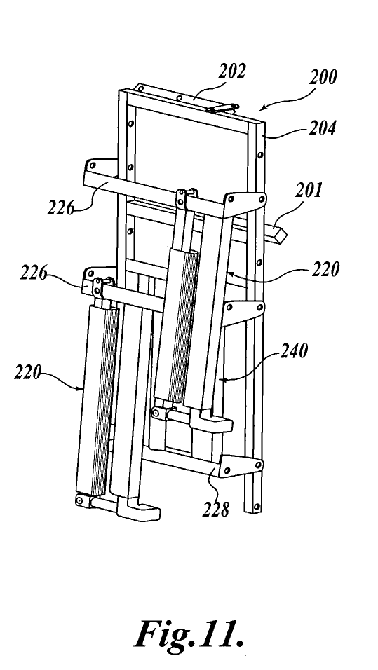

As seen most clearly in FIG. 11, when the retaining frame assembly 200 is not in use—for example, during storage—the first and second hinged rails 226, 228 allow the upper and lower retaining members 220, 240 to be conveniently pivoted towards the frame 204.

It will now be appreciated that this second embodiment of the present invention also provides an apparatus for attaching gear, such as skis 94, to the rear of a vehicle, with the gear disposed at an angle, e.g., generally diagonally, across the back of the vehicle. The second embodiment is used similarly to the first embodiment. The gear to be retained is inserted into the lower retaining members 240, and then laid against the sheathed fixed bar 222 of the corresponding upper retaining member 220. The hinged bar 224 is pivoted over the gear, and cooperatively with the lower retaining member 240, secures the gear to the assembly 200.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A rack assembly for retaining gear at the rear of a vehicle, the vehicle defining a vertical plane and having oppositely disposed first and second sides, the rack assembly comprising:
a lower retaining member adapted to be attached to the rear of the vehicle, wherein the lower retaining member is disposed at a first elevation, and near the first side of the vehicle; and
an upper retaining member adapted to be attached to the rear of the vehicle, wherein the upper retaining member is disposed at a second elevation that is higher than the first elevation, and near the second side of the vehicle;
wherein gear retained by both the lower retaining member and the upper retaining members will be oriented at an angle of between 20 degrees and 70 degrees with respect to the vertical plane defined by the vehicle.

2. The rack assembly of claim 1, wherein gear retained by both the lower retaining member and the upper retaining member will be oriented at an angle of between 35 degrees and 55 degrees with respect to the vertical plane defined by the vehicle.

3. The rack assembly of claim 1, further comprising a support assembly having a first end adapted to be attached directly to the vehicle and a second end adapted to receive the lower retaining member and the upper retaining member.

4. The rack assembly of claim 3, wherein the lower retaining member comprises a rearwardly-extending rigid hoop that is oriented to receive one end of the gear, and the upper retaining member comprises a rearwardly-extending first bar having a clamp for releasably engaging the gear.

5. The rack assembly of claim 4, wherein the clamp for releasably engaging the elongate gear comprises a second bar that is pivotally attached to the first bar.

6. The rack assembly of claim 5, further comprising a lock assembly adapted to lock the second bar to the first bar.

7. The rack assembly of claim 5, wherein the lower retaining member further comprises a protective sheath disposed about at least a portion of the rigid hoop.

8. The rack assembly of claim 1, further comprising a second upper retaining member and a second lower retaining member.

9. The rack assembly of claim 1, wherein the upper retaining member and the lower retaining member are adapted to fold toward the vehicle.

10. The rack assembly of claim 1 wherein the upper retaining member and the lower retaining member are adapted to retain a plurality of pairs of skis.

11. A sports rack for releasably retaining an elongate item near the rear of an automobile, the sports rack comprising:
a first retaining member including a rigid hoop defining an elongate slot that is adapted to receive one end of an elongate item; and
a second retaining member including a first rigid bar and a clamp attached to the rigid bar, the second retaining member adapted to engage the elongate item near an opposite end;
wherein the first and second retaining members extend rearwardly from the automobile, and are vertically and transversely offset such that the retained elongate item is oriented at an angle of between about 20 degrees and about 70 degrees with respect to a vertical plane.

12. The sports rack of claim 11, wherein the retained elongate item is oriented at an angle of between 35 degrees and 55 degrees with respect to a vertical plane.

13. The sports rack of claim 11, further comprising a support assembly having a first end adapted to be attached directly to the vehicle and a second end adapted to receive the first retaining member and the second retaining member.

14. The sports rack of claim 11, wherein the clamp attached to the first rigid bar comprises a second bar that is pivotally attached to the first rigid bar.

15. The sports rack of claim 14, further comprising a lock assembly adapted to lock the second bar to the first rigid bar.

16. The sports rack of claim 11, wherein the lower retaining member further comprises a protective sheath disposed about at least a portion of the rigid hoop.

17. The sports rack of claim 11, wherein the first retaining member and the second retaining member are adapted to fold toward the vehicle.

18. The sports rack of claim 11, wherein the first retaining member and the second retaining member are adapted to retain a plurality of pairs of skis.

19. A rack assembly for a vehicle defining a horizontal plane, the rack assembly comprising:
a support assembly having a first end and a second end, wherein the first end includes a keyed post and the second end includes a first and a second keyed aperture;
a lower retaining member having a keyed post adapted to slidably engage the support assembly first keyed aperture, an extension bar extending downwardly and outwardly from the keyed post, and a rigid hoop extending rearwardly from the extension bar, the rigid hoop defining a first gear retention slot; and
an upper retaining member having a keyed post adapted to slidably engage the support assembly second keyed aperture, a first bar extending rearwardly from the keyed post, and a second bar hingedly attached to the first bar, the first and second bars defining a second gear retention slot;
wherein the first and second gear retention slots are disposed relative to each other such that a straight line through the first and second gear retention slots will form an angle between about 20 degrees and about 70 degrees relative to the horizontal plane defined by the vehicle.

20. The rack assembly of claim 19, wherein the first and second gear retention slots are disposed relative to each other such that a straight line through the first and second gear retention slots will form an angle between about 35 degrees and about 55 degrees relative to the horizontal plane defined by the vehicle.

21. The rack assembly of claim 19, further comprising a lock assembly adapted to lock the second bar to the first bar.

22. The rack assembly of claim 19, wherein the lower retaining member further comprises a protective sheath disposed about at least a portion of the rigid hoop.

23. The rack assembly of claim 19, further comprising a second upper retaining member and a second lower retaining member.

24. The rack assembly of claim 19, wherein the upper retaining member and the lower retaining member are adapted to fold toward the vehicle.

25. The rack assembly of claim 19, wherein the upper retaining member and the lower retaining member are adapted to retain a plurality of pairs of skis.
